(19) United States
(12) Patent Application Publication
(10) Pub. No.: US 2010/0034335 A1
(43) Pub. Date: Feb. 11, 2010

(54) ARTICLES HAVING ENHANCED WETTABILITY

(75) Inventors: Kripa Kiran Varanasi, Clifton Park, NY (US); Nitin Bhate, Rexford, NY (US); Ming Feng Hsu, Niskayuna, NY (US); Andrew Maxwell Peter, Saratoga Springs, NY (US); Tao Deng, Clifton Park, NY (US); Gregory Allen O'Neil, Clifton Park, NY (US); Judith Stein, Schenectady, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/612,946

(22) Filed: Dec. 19, 2006

(51) Int. Cl. G21C 3/04; B32B 3/00

(52) U.S. Cl. 376/412; 428/195.1; 428/156; 428/601

(57) ABSTRACT

Articles having surfaces with enhanced wetting properties are presented. One embodiment is an article having a surface configured for promoting a phase transformation from a liquid phase to a vapor phase. The article comprises an element comprising a surface disposed to be in contact with a liquid to be transformed to a vapor, and the surface comprises a plurality of surface features having a median feature size, a, and a median feature spacing, b, such that the ratio b/a is up to about 8. The surface comprises a material disposed to contact the liquid, and this material has a nominal wettability sufficient to generate a nominal contact angle of up to about 80 degrees with a drop of the liquid. Another embodiment is a fuel rod for a nuclear reactor comprising a surface configured as described above.

### BACKGROUND

This invention relates to articles having enhanced wettability. More particularly, this invention relates to articles having surfaces engineered to promote increased wetting of the surfaces by liquids.

The “liquid wettability”, or “wettability,” of a solid surface is determined by observing the nature of the interaction occurring between the surface and a drop of a given liquid disposed on the surface. A surface having a high wettability for the liquid tends to allow the drop to spread over a relatively wide area of the surface (thereby “wetting” the surface). In the extreme case, the liquid spreads into a film over the surface. On the other hand, where the surface has a low wettability for the liquid, the liquid tends to retain a well-formed, ball-shaped drop. In the extreme case, the liquid forms spherical drops on the surface that easily roll off of the surface at the slightest disturbance.

The extent to which a liquid is able to wet a solid surface plays a significant role in determining how the liquid and solid will interact with each other. By way of example, so-called “hydrophilic” materials have relatively high wettability in the presence of water, resulting in a high degree of “sheeting” of the water over the solid surface. A high degree of wetting results in relatively large areas of liquid-solid contact, and is desirable in applications where a considerable amount of interaction between the two surfaces is beneficial, such as, for example, adhesive and coating applications, certain medical device applications, and applications involving boiling or evaporation heat transfer mechanisms.

In practice, techniques for increasing the wetting of surfaces often involve adding surfactants to the contacting fluid. However, in many applications it will be difficult or nearly impossible to add surfactants to a fluid. Therefore, there is a need to provide articles with durable surfaces having high liquid wettability.

### BRIEF DESCRIPTION

Embodiments of the present invention meet these and other needs. One embodiment is an article having a surface configured for promoting a phase transformation from a liquid phase to a vapor phase. The article comprises an element comprising a surface disposed to be in contact with a liquid to be transformed to a vapor, and the surface comprises a plurality of surface features having a median feature size, a, and a median feature spacing, b, such that the ratio b/a is up to about 8. The surface comprises a material disposed to contact the liquid, and this material has a nominal wettability sufficient to generate a nominal contact angle of up to about 80 degrees with a drop of the liquid. In particular embodiments, the liquid is water.

Another embodiment is a fuel rod for a nuclear power reactor, comprising: a cladding portion surrounding a nuclear fuel material, wherein the cladding portion comprises a surface disposed to be in contact with a liquid flowing or impinging upon the rod, the surface comprising a plurality of surface features having a median feature size, a, and a median feature spacing, b, such that the ratio b/a is up to about 8; wherein the surface comprises a material disposed to contact the liquid, the material having an nominal wettability sufficient to generate a nominal contact angle of up to about 80 degrees with a drop of the liquid.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional schematic of an embodiment of the present invention;

FIG. 2 is a cross-sectional schematic of another embodiment of the present invention;

FIG. 3 is a plot of contact angle as a function of relative spacing for various aspect ratios, where the features are pores;

FIG. 4 is a plot of contact angle as a function of relative spacing for various aspect ratios, where the features are grooves;

FIG. 5 is a plot of contact angle as a function of relative spacing for various aspect ratios, where the features are protrusions;

FIG. 6 is a cross-sectional schematic of another embodiment of the present invention;

FIG. 7 is a cross-sectional schematic of a fuel rod embodiment of the present invention;

FIG. 8 is a plot of effective contact angle as a function of surface area; and

FIG. 9 is a plot of contact angle measured as a function of relative spacing of surface features.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

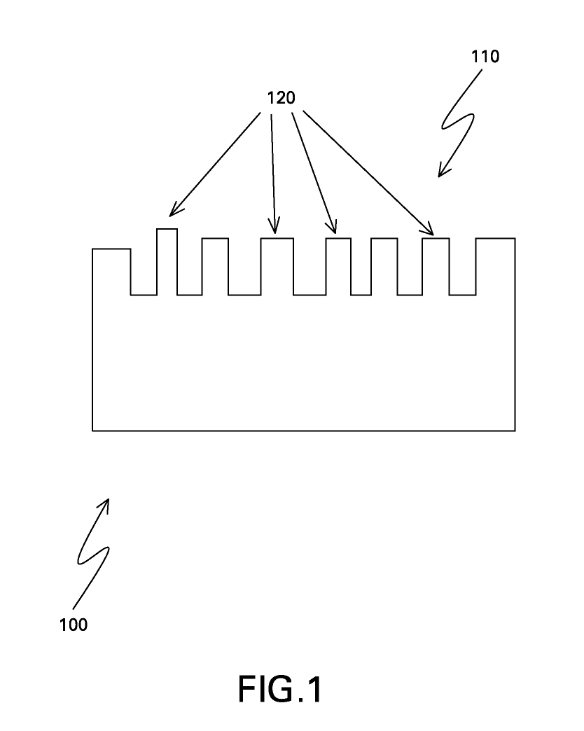

Referring to the drawings in general and to FIG. 1 in particular, it will be understood that the illustrations are for the purpose of describing a particular embodiment of the invention and are not intended to limit the invention thereto. FIG. 1 is a schematic cross-sectional view of a surface of an article of the present invention. Article 100 has a surface 110 configured for promoting enhanced wetting of surface 110 by a reference liquid (not shown).

One commonly accepted measure of the liquid wettability of a surface is the value of the static contact angle formed between the surface and a tangent to a surface of a droplet of a reference liquid at the point of contact between the surface and the droplet. Low values of the contact angle indicate a high wettability for the reference liquid on surface. The reference liquid may be any liquid of interest. In many applications, the reference liquid is water. In other applications, the reference liquid is a liquid that contains at least one hydrocarbon, such as, for example, oil, petroleum, gasoline, an organic solvent, and the like. Because wettability depends in part upon the surface tension of the reference liquid, a given surface may have a different wettability (and hence form a different contact angle) for different liquids.

Surface 110 comprises a plurality of surface features 120. The size, shape, and orientation of features 120 have a strong effect on the wettability of surface 110, and in embodiments of the present invention these parameters are selected such that the surface 110 has a high liquid wettability. The selection is based upon the physics underlying the interaction of liquids and rough solid surfaces.

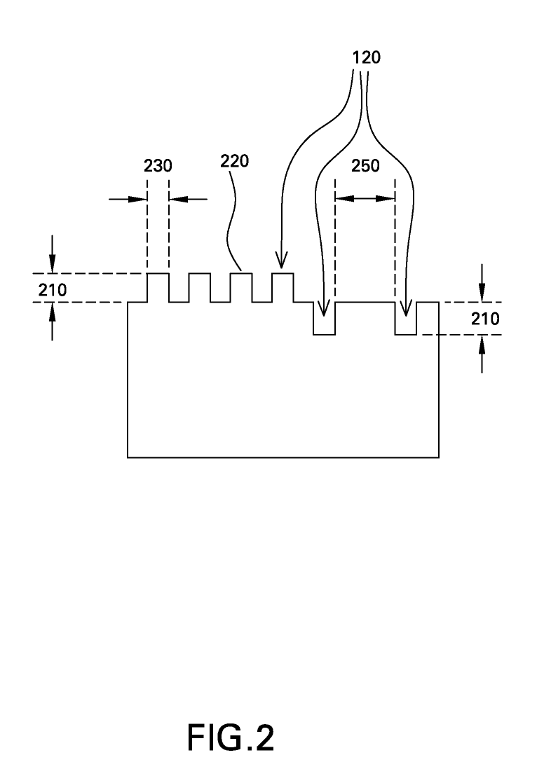

The size of features 120 can be characterized in a number of ways. In some embodiments, as shown in FIG. 2, at least a subset of the plurality of features 120 protrudes from article 100. Moreover, in some embodiments at least a subset of the plurality of features is a plurality of cavities 200 disposed in the article 100. Features 120 comprise a height dimension (h) 210, which represents the height of protruding features 220 or, in the case of cavities 200, the depth to which the cavities extend into article 100. Features 120 further comprise a width dimension (a) 230. The precise nature of the width dimension will depend on the shape of the feature, but is defined to be the width of the feature at the point where the feature would naturally contact a drop of liquid placed on the surface of the article. The height and width parameters of features 120 have a significant effect on wetting behavior observed on surface 110.

Numerous varieties of feature shapes are suitable for use as features 120. In some embodiments, at least a subset of the features 120 has a shape selected from the group consisting of a cube, a rectangular prism, a cone, a cylinder, a pyramid, a trapezoidal prism, and a hemisphere or other spherical portion. These shapes are suitable whether the feature is a protrusion 220, such as a pedestal, or a cavity 200, such as a groove or a pore. As an example, in particular embodiments, at least a subset of the features comprises nanowires, which are structures that have a lateral size constrained to tens of nanometers or less and an unconstrained longitudinal size. Methods for making nanowires of various materials are well known in the art, and include, for example, chemical vapor deposition onto a substrate. Nanowires may be grown directly on article 100 or may be grown on a separate substrate, removed from that substrate (for example, by use of ultrasonication), placed in a solvent, and transferred onto article 100 by disposing the solvent onto the article surface and allowing the solvent to dry.

Feature orientation is a further design consideration in the engineering of surface wettability in accordance with embodiments of the present invention. One significant aspect of feature orientation is the spacing of features. Referring to FIG. 2, in some embodiments features 120 are disposed in a spaced-apart relationship characterized by a spacing dimension (b) 250. Spacing dimension 250 is defined as the distance between the edges of two nearest-neighbor features.

In some embodiments, all of the features 120 in the plurality are disposed in a nonrandom distribution. In some cases features 120 have substantially the same respective values for h, a, and/or b (“an ordered array”), though this is not a general requirement. For example, the plurality of features 120 may be a collection of features, such as nanowires, for instance, exhibiting a random distribution of size, shape, and/or orientation. In certain embodiments, moreover, the plurality of features is characterized by a multi-modal distribution (e.g., a bimodal or trimodal distribution) in h, a, b, or any combination thereof. Such distributions may advantageously provide enhanced wettability in environments where a range of drop sizes is encountered. Estimation of the effects of h, a, and b on wettability are thus best performed by taking into account the distributive nature of these parameters. Techniques, such as Monte Carlo simulation, for performing analyses using variables representing probability distributions are well known in the art. Such techniques may be applied in designing features 120 for use in articles of the present invention.

Surface 110 is made of a material disposed to contact the liquid, and this material has a nominal wettability sufficient to generate a nominal contact angle of up to about 80 degrees with a drop of the liquid. As used herein, a “nominal contact angle” means the static contact angle measured where a drop of a reference liquid is disposed on a flat, smooth surface of the material. This nominal contact angle is a measurement of the “nominal wettability” of the material, and may be contrasted with the “effective wettability” of the surface, which is the wettability measured for surface 110 after the surface 110 has been provided with texture, such as features 120 as described above. Generally, the use of a material having a lower nominal contact angle results in a lower effective contact angle for a given disposition of surface features 120. In certain embodiments, the nominal contact angle is up to about 70 degrees, and in particular embodiments, the nominal contact angle is up to about 60 degrees.

A variety of materials meet these requirements for comparatively high nominal wettability. In some embodiments, the material comprises a metal, such as a metal comprising an element selected from the group consisting of iron, titanium, copper, zirconium, aluminum, and nickel. In certain embodiments the material is essentially completely metallic. In other embodiments, the material comprises a ceramic, such as an oxide typified by titanium oxide, silicon dioxide, and zirconium oxide. The material may be present as a coating disposed on article 100, or features 120 may be made of the material. Other mildly to very hydrophilic materials, such as, for example, certain polymeric materials, may be used in embodiments of the present invention. However, the low thermal conductivity of most polymers may make them unattractive for use in certain applications, and so in some embodiments the surface 110 is essentially free of polymeric material.

The present inventors have found that specific ranges and combinations of the surface parameters described above provide a regime in which the effective wettability of surface 110 may be driven to values significantly above that of the nominal wettability of the material used to form surface 110. For example, in certain embodiments, the surface has an effective wettability sufficient to generate an effective contact angle of up to about 15 degrees with a drop of the reference liquid. In some cases it has been shown that the effective contact angle may be reduced to near zero.

In embodiments of the present invention, surface 110 comprises a plurality of surface features 120 having a median feature size, a, and a median feature spacing, b, such that the ratio b/a is up to about 8. In particular embodiments, b/a is up to about 6, and in certain embodiments is up to about 3. A lower b/a indicates more closely spaced features, and as these features are more closely spaced, the surface area of surface 110 increases, providing more contact area for the liquid. However, in some situations there is a practical lower limit as to how closely features may be spaced, due in part to limitations in fabrication methods. Moreover, in certain applications, spacing features 120 too closely together may cause a situation in which droplets of liquid are suspended between features, without wetting the areas between features 120. Such a condition would reduce the effective wetting area. Accordingly, in some embodiments b/a is at least about 0.5, and in some cases at least about 2. In particular embodiments, b/a is in the range from about 0.5 to about 6, and in certain embodiments b/a is in the range from about 2 to about 4, though any range within the endpoint parameters described herein may be suitable in particular applications.

The aspect ratio (h/a) of features 120 also plays a role in determining the effective wetting behavior of surface 110. Generally, high aspect ratios, such as at least about 1 and, in some situations, at least about 4, are desirable because surface area increases as aspect ratio increases. In some high temperature heat transfer application conditions, such as, for instance, the type experienced by nuclear fuel rods, high aspect ratio (h/a at least about 4) features are desirably sized and spaced apart to give b/a in the range from about 0.5 to about 6. This combination of parameter values provides a surface that maximizes heat transfer by impinging droplets or by a flowing liquid film.

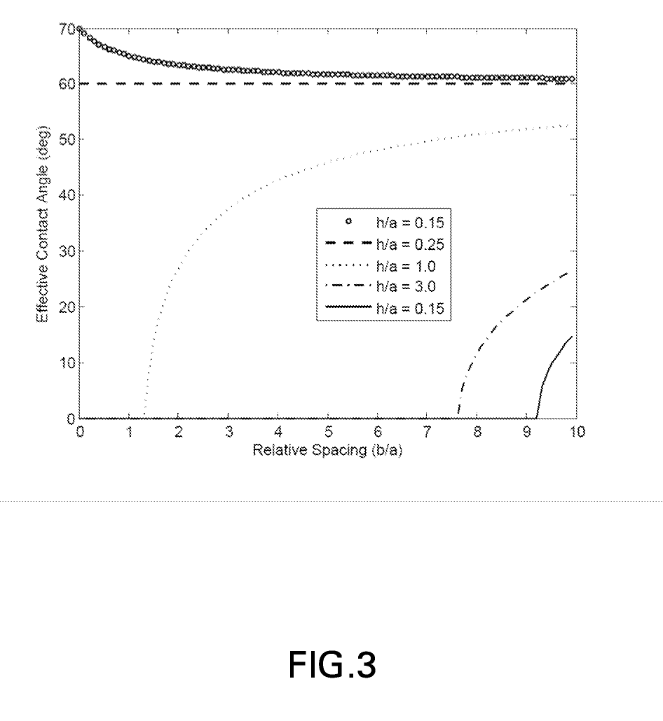

As stated above, in some embodiments at least a subset of the plurality of features is a plurality of cavities 200, such as, for example, pores, disposed in the article 100. By analyzing the interaction between liquids and surfaces having cavities, the present inventors have discovered certain texture parameter combinations that result in enhanced wettability of the surface 110. FIG. 3, the results of an exemplary analysis wherein the surface features are pores, the nominal contact angle of the surface material is 60 degrees, and the reference liquid is water, suggests that where the aspect ratio (h/a) is 0.25 or less, there should be no enhancement, and there may even be a reduction, in the wettability of the surface. Consequently, in some embodiments, the aspect ratio of the cavities is greater than 0.25. FIG. 3 indicates that as the aspect ratio of the pores increases, the relative spacing of the cavities may be higher while maintaining very low wettability. For example, according to FIG. 3, where h/a is about 1, b/a of up to about 1 provides for a very low contact angle, while for h/a of about 3, b/a of up to about 6 provides for a very low contact angle. In some embodiments, h/a is at least about 1, and h/a is at least about 3 in particular embodiments.

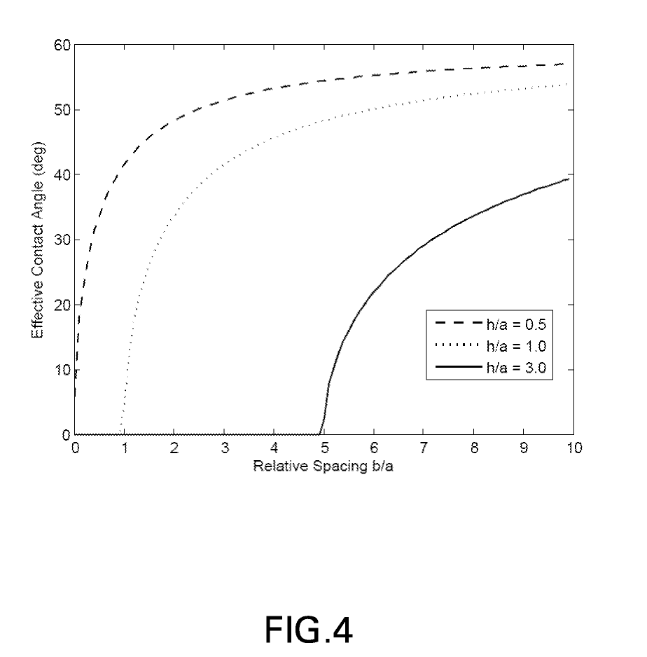

In some embodiments, the cavities include a plurality of grooves. FIG. 4, the results of an exemplary analysis wherein the surface features are grooves, the nominal contact angle of the surface material is 60 degrees, and the reference liquid is water, suggests that where the aspect ratio (h/a) is 0.5 or less, there should be very little enhancement in surface wettability. In some embodiments, h/a is at least 0.5. Similar to the situation for pores, described above, as groove aspect ratio increases, so does the range of relative spacing that can provide desirably low contact angle. In some embodiments, h/a is at least about 1, and in particular embodiments h/a is at least about 3.

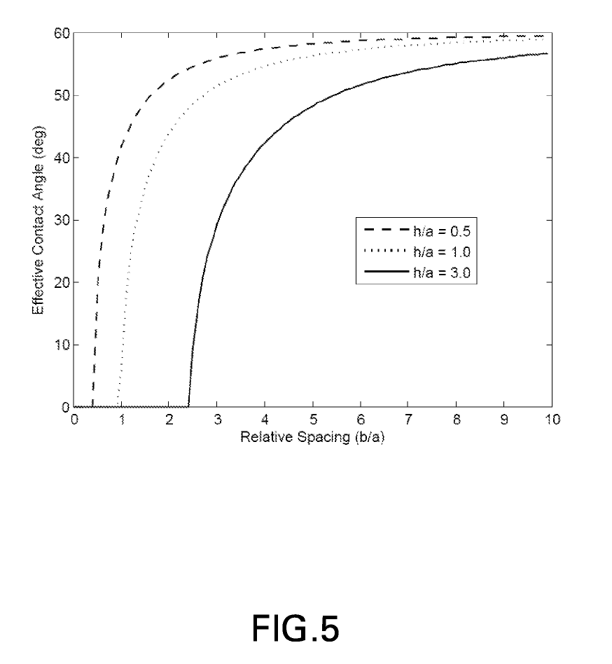

The trend described above for cavities, in which the range of b/a which gives very low contact angles expands as the aspect ratio of surface features increases, is also found to hold true where the features 120 are protrusions. This trend is illustrated in FIG. 5.

Features 120 can be fabricated and provided to article 100 by a number of methods. In some embodiments, features 120 are fabricated directly on surface 110. In other embodiments, features 120 are fabricated separately and then disposed onto article 100. Disposition of features 120 onto article 100 can be done by individually attaching features 120, or the features may be disposed on a sheet, foil or other suitable medium that is then attached to the article 100. Attachment in either case may be accomplished through any appropriate method, such as, but not limited to, welding, brazing, mechanically attaching, or adhesively attaching via epoxy or other adhesive.

The disposition of features 120 may be accomplished by disposing material onto the surface of the article, by removing material from the surface, or a combination of both depositing and removing. Many methods are known in the art for adding or removing material from a surface. For example, simple roughening of the surface by mechanical operations such as grinding, grit blasting, or shot peening may be suitable if appropriate media/tooling and surface materials are selected. Such operations will generally result in a distribution of randomly oriented features on the surface, while the size-scale of the features will depend significantly on the size of the media and/or tooling used for the material removal operation. General roughening of surfaces to promote enhanced wetting has been described previously. See, for example, U.S. patent application Ser. No. 11/206,565. However, certain embodiments of the present invention require control over specific parameters such as relative spacing and aspect ratio of features 120 to provide improved wetting performance. Many of the parameter ranges and combinations thereof are very difficult or impossible to achieve via the use of traditionally described roughening processes such as grit blasting, for example.

Lithographic methods are commonly used to create surface features on etchable surfaces, including metal surfaces. Ordered arrays of features can be provided by these methods; the lower limit of feature size available through these techniques is limited by the resolution of the particular lithographic process being applied. Lithography and other etching methods are generally not well-suited to the formation of high aspect ratio features on some metal surfaces, however, due to the tendency to “undercut,” i.e., to etch laterally as well as vertically.

Electroplating methods are also commonly used to add features to surfaces. An electrically conductive surface may be masked in a patterned array to expose areas upon which features are to be disposed, and the features may be built up on these exposed regions by plating. This method allows the creation of features having higher aspect ratios than those commonly achieved by etching techniques. In particular embodiments, the masking is accomplished by the use of an anodized aluminum oxide (AAO) template having a well-controlled pore size. Material is electroplated onto the substrate through the pores, and the AAO template is then selectively removed; this process is commonly applied in the art to make high aspect ratio features such as nanorods. Nanorods of metal and metal oxides may be deposited using commonly known processing, and these materials may be further processed (by carburization, for example) to form various ceramic materials such as carbides. As will be described in more detail below, coatings or other surface modification techniques may be applied to the features to provide even better wettability properties.

Micromachining techniques, such as laser micromachining (commonly used for silicon and stainless steels, for example) and etching techniques (for example, those commonly used for silicon) are suitable methods as well. Such techniques may be used to form cavities (as in laser drilling) as well as protruding features. Where the plurality of features 120 includes cavities 200, in some embodiments article 100 comprises a porous material, such as, for example, an anodized metal oxide. Anodized aluminum oxide is a particular example of a porous material that may be suitable for use in some embodiments. Anodized aluminum oxide typically comprises columnar pores, and pore parameters such as diameter and aspect ratio may be closely controlled by the anodization process, using process controls that are well known to the art to convert a layer of metal into a layer of porous metal oxide.

In short, any of a number of deposition processes or material removal processes commonly known in the art may be used to provide features to a surface. As described above, the features may be applied directly onto article 100, or applied to a substrate that is then attached to article 100.

Embodiments of the present invention may be particularly of use in heat transfer applications, particularly in those applications involving evaporative heat transfer or boiling heat transfer. Although the use of textured surfaces in boiling heat transfer applications has been described previously, the function of the texture in these previously described applications generally has been to provide nucleation sites for bubbles to form during the boiling process. In contrast, the function of the textured surfaces described herein is to enhance the wetting of the surface by the liquid. As a result of this difference in function, the size, shape, and orientation of the features 120 on the surface 110 varies from that described for bubble nucleation enhancement. For example, in U.S. Pat. No. 4,312,012, the surface is designed to discourage complete wetting by the boiling fluid so that bubble nucleation may be enhanced. Furthermore, in U.S. Pat. No. 4,767,497, submicron-sized features (pits) are described as being undesirable due to bubble nucleation and agglomeration concerns. In embodiments of the present invention, the use of submicron-sized features 120 may be suitable for many applications so long as the required ratios for b/a and h/a are met. In other embodiments, at least one of a and b is less than about 100 micrometers, such as less than about 50 micrometers.

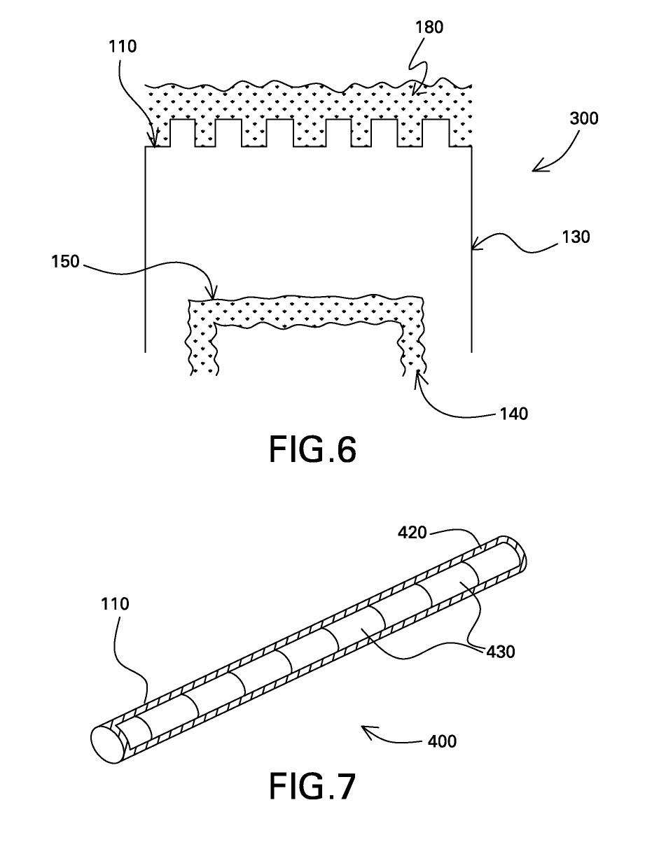

Accordingly, as shown in FIG. 6, one embodiment of the present invention is an article 300 having a surface 110 configured for promoting a phase transformation from a liquid phase to a vapor phase. Article 100 comprises an element 130 having surface 100 as described above. In some embodiments, article 300 is a boiler or an evaporator, such as, for instance, an evaporator in a thermal desalination system. The general configuration of such devices is well known in the art and is not described in detail herein. However, for illustrative purposes, FIG. 6 shows that in typical applications of this type, surface 110 is disposed so that evaporation or boiling of a first fluid 180 will occur at surface 110, thereby reducing the temperature of element 130. In some embodiments, a secondary fluid 140, in thermal contact with an opposite surface 150 of element 130 but kept separate from any fluid contacting surface 110, may be cooled due to the transfer of heat to the cooled element 130. Due to the enhanced wetting of surface 110 by first fluid 180, evaporation of first fluid 180 occurs more efficiently, as more surface area is contacted by a given volume of fluid, resulting in a thinner, more easily evaporated fluid layer. Element 130 may be any heat transfer element in an apparatus that promotes heat transfer via evaporation, or in other embodiments, in an apparatus that promotes heat transfer by boiling.

One particular embodiment of the present invention, as illustrated in FIG. 7, is a fuel rod 400 for a nuclear power reactor. In such systems, nuclear fuel contained in a core comprised of a bundle of vertically oriented fuel rods produces sufficient heat to boil water, thereby producing steam that can drive steam turbine equipment to generate electricity. Enhanced wettability of the fuel cladding surface may increase the bundle critical power, or the maximum thermal power which the bundle may produce at a given cooling flow inlet condition before some location on the fuel surface is exhausted of water film cooling, a condition known as “boiling transition” or “dryout”. Additionally, enhanced wetting of the surface by droplet impingement may promote efficient heat transfer from the rods to the coolant during “post boiling transition” or “post dryout” events. Such events can occur during operational transients or during accidents when Emergency Core Cooling (ECC) systems are activated. Increasing the wettability of the fuel cladding surface may enhance the heat transfer in these situations by increasing the wettability of the surface as well as by providing a path for vapor escape from underneath the impinging droplet. This can also lead to an increase in the droplet rewetting temperature limit, or the maximum temperature at which an impinging droplet can effectively wet the surface, sometimes knows as the “Leidenfrost temperature”.

According to embodiments of the present invention, rod 400 comprises a cladding portion 420 surrounding fuel pellets 430. In some embodiments, cladding is a metal, such as an alloy containing zirconium. Surface 110 as described previously is disposed on cladding portion 420 so that contact between rod 400 and a liquid flowing or impinging upon rod 400 occurs at surface 110. In one embodiment surface 110 comprising surface features 120 (FIG. 1) is disposed on the entire rod, and in other embodiments surface 110 comprising surface features 120 is disposed only on specific areas of rod 400. For example, it is known in the art that flow of water along the fuel rods in a Boiling Water Reactor core will go through a transition to an annular flow regime, where vapor becomes the continuous medium and liquid water is either found as a thin film flowing on all the solid surfaces of the bundle or as droplets entrained in the continuous vapor. This transition often occurs below the midpoint of the fuel rod length, with annular flow continuing along the remaining length of the rod until the flow reaches its outlet at the top of the fuel rod bundle. The annular flow regime is important because it is where dryout or boiling transition will commonly take place in a boiling water reactor, and thus in some embodiments the surface features 120 are disposed only in that region of the tube 400 susceptible to annular flow, to better spread the water film and thus forestall an adverse dryout condition as well as improve post-dryout heat transfer.

The parameters characterizing surface 110 of rod 400 coincide with those described previously. In some embodiments, a is in the range from about 1 micrometer to about 25 micrometers, such as from about 5 micrometers to about 15 micrometers. In some embodiments, b is in the range from about 5 micrometers to about 75 micrometers, such as from about 15 micrometers to about 45 micrometers. In some embodiments, h is in the range from about 10 micrometers to about 100 micrometers. These values may give desirable levels of performance given the particular temperature and flow conditions encountered in the nuclear power reactor environment. Moreover, the present inventors have found, surprisingly, that high aspect ratio features, that is, those with h/a>1 and in some cases h/a>4, show measurable increases in Leidenfrost temperature, while low aspect ratio features (h/a below about 1) do not show this effect.

### Examples

The following examples are set forth to further illustrate embodiments of the present invention, and are not meant to limit the scope of embodiments of the invention in any way.

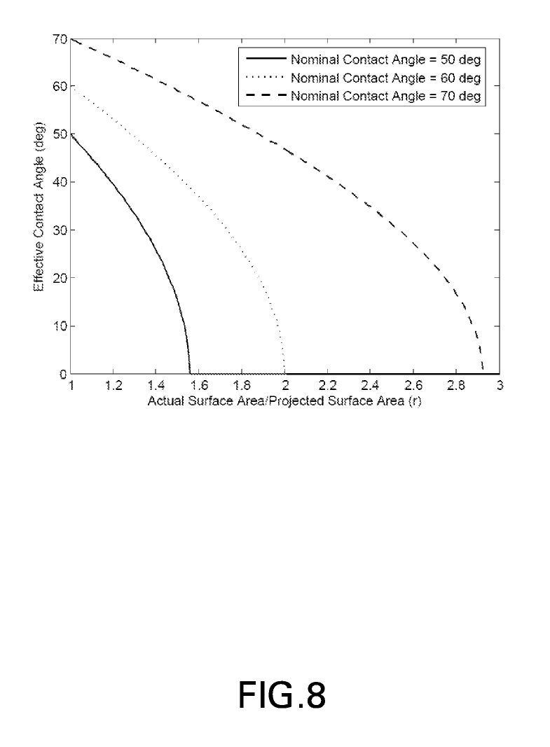

FIG. 8 shows plots of data generated by a physics-based model of surfaces in accordance with embodiments of the present invention. In this figure, the relationship between the surface area of the surface (as measured by r, the ratio of actual surface area to projected surface area) and the effective contact angle formed with water is plotted for surfaces having nominal contact angles of 50 degrees, 60 degrees, and 70 degrees. It will be apparent that the r parameter is a function of the geometry of the surface, including such parameters as b/a and h/a, and that the nature of the particular function will depend on the configuration of the surface. As is shown in FIG. 8, a critical r value exists for a surface of a given nominal contact angle at which the effective contact angle goes to zero, and the use of rougher surfaces (i.e. surfaces having higher r values) than the critical r value has no further effect on the effective contact angle. This critical r value increases as the nominal contact angle of the surface material increases. In some embodiments of the present invention, the surface is designed to have an r value of at least the critical r value indicated by an analysis of the type illustrated in FIG. 5. In other embodiments, the surface is designed to have a contact angle below a certain value. For example, where the desired maximum contact angle with water is to be 20 degrees, and the material to be used to fabricate surface 110 is a material such as a metal having a nominal contact angle of about 60 degrees, FIG. 8 dictates that the surface features 120 should be designed and disposed such that the r value of the surface is at least about 1.9.

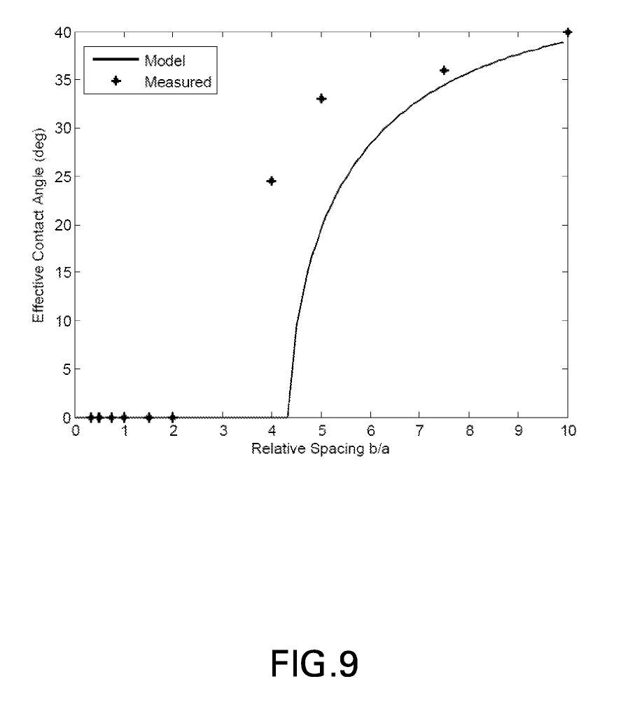

To further illustrate embodiments of the present invention, silicon surfaces were given textures made of matrices of square pedestals 3 micrometers in width, having various respective b/a values and having h/a of about 3. The static contact angle of these surfaces with water was measured to determine the effect of relative spacing on the contact angle. The contact angle measured on a smooth (untextured) silicon surface was found to be about 45 degrees. Measurements on silicon wafers with square pedestals show that for a certain range of b/a the contact angle is as low as zero degrees. These results are shown in FIG. 9. The measured values are plotted as points, and the solid line represents the effective contact angle as predicted by the model. The plot suggests that a b/a of less than about 3 is needed in this situation to maintain a contact angle of about zero.

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. An article having a surface configured for promoting a phase transformation from a liquid phase to a vapor phase, the article comprising:
an element comprising a surface disposed to be in contact with a liquid to be transformed to a vapor, the surface comprising a plurality of surface features having a median feature size, a, and a median feature spacing, b, such that the ratio b/a is up to about 8;
wherein the surface comprises a material disposed to contact the liquid, the material having a nominal wettability sufficient to generate a nominal contact angle of up to about 80 degrees with a drop of the liquid.

2. The article of claim 1, wherein b/a is up to about 6.

3. The article of claim 1, wherein b/a is up to about 3.

4. The article of claim 1, wherein at least one of a and b is less than about 100 micrometers.

5. The article of claim 1, wherein at least one of a and b is less than about 50 micrometers.

6. The article of claim 1, wherein b/a is at least about 0.5.

7. The article of claim 1, wherein b/a is at least about 2.

8. The article of claim 1, wherein b/a is in the range from about 0.5 to about 6.

9. The article of claim 1, wherein b/a is in the range from about 2 to about 4.

10. The article of claim 1, wherein the plurality of surface features has a median height displacement, h, above or below the surface, and wherein the ratio h/a is at least about 0.5.

11. The article of claim 8, wherein h/a is at least about 4.

12. The article of claim 11, wherein b/a is in the range from about 0.5 to about 6.

13. The article of claim 1, wherein the plurality of surface features comprises a plurality of pedestals protruding above the surface.

14. The article of claim 1, wherein the plurality of surface features comprises a plurality of cavities disposed on the surface.

15. The article of claim 14, wherein the plurality of cavities comprises a plurality of features disposed on the surface, the features selected from the group consisting of pores and grooves.

16. The article of claim 14, wherein the plurality of cavities comprises a plurality of pores having a median depth, h, to which the pores extend into the article, and wherein h/a is at least about 0.25.

17. The article of claim 14, wherein the plurality of cavities comprises a plurality of grooves having a median depth, h, to which the grooves extend into the article, and wherein h/a is at least about 0.5.

18. The article of claim 14, wherein the plurality of cavities has a median depth, h, to which the cavities extend into the article, and wherein h/a is at least about 1.

19. The article of claim 14, wherein the plurality of cavities has a median depth, h, to which the cavities extend into the article, and wherein h/a is at least about 3.

20. The article of claim 1, wherein the nominal contact angle is up to about 70 degrees.

21. The article of claim 1, wherein the nominal contact angle is up to about 60 degrees.

22. The article of claim 1, wherein the material comprises a metal.

23. The article of claim 22, wherein the metal comprises an element selected from the group consisting of iron, titanium, copper, zirconium, aluminum, and nickel.

24. The article of claim 1, wherein the material comprises a coating disposed on the article.

25. The article of claim 1, wherein the material comprises a ceramic.

26. The article of claim 25, wherein the ceramic comprises an oxide.

27. The article of claim 26, wherein the oxide comprises at least one oxide selected from the group consisting of titanium oxide, silicon dioxide, and zirconium oxide.

28. The article of claim 1, wherein the surface has an effective wettability sufficient to generate an effective contact angle of up to about 15 degrees with a drop of the reference liquid.

29. The article of claim 1, wherein the article is a boiler or an evaporator.

30. The article of claim 1, wherein the article is a fuel rod for a nuclear reactor.

31. A fuel rod for a nuclear power reactor, comprising:
a cladding portion surrounding a nuclear fuel material, wherein the cladding portion comprises a surface disposed to be in contact with a liquid flowing or impinging upon the rod, the surface comprising a plurality of surface features having a median feature size, a, and a median feature spacing, b, such that the ratio b/a is up to about 8;
wherein the surface comprises a material disposed to contact the liquid, the material having an nominal wettability sufficient to generate a nominal contact angle of up to about 80 degrees with a drop of the liquid.

32. The fuel rod of claim 31, wherein the surface features are disposed over the entire surface of the cladding portion.

33. The fuel rod of claim 31, wherein the surface features are disposed on less than the entire surface of the cladding portion.

34. The fuel rod of claim 31, wherein b/a is in the range from about 0.5 to about 6.

35. The fuel rod of claim 31, wherein b/a is in the range from about 2 to about 4.

36. The fuel rod of claim 31, wherein the plurality of surface features has a median height displacement, h, above or below the surface, and wherein the ratio h/a is at least about 4.
